(19) United States
(12) Patent Application Publication
(10) Pub. No.: US 2026/0018072 A1
(43) Pub. Date: Jan. 15, 2026

(54) SYSTEM AND METHOD FOR DIGITAL EDUCATIONAL CONTENT

(71) Applicant: Meego Technology Limited, Sheung Wan (HK)

(72) Inventors: Kathleen Ting, Sheung Wan (HK); Alexander Ting, Sheung Wan (HK); Hong Alexander Chao, Sheung Wan (HK)

(21) Appl. No.: 18/998,409

(22) PCT Filed: Jul. 25, 2023
(86) PCT No.: PCT/IB2023/057518

§ 371 Date: Jan. 24, 2025

(30) Foreign Application Priority Data
Jul. 25, 2022 (HK) 32022057220.2

(51) Int. Cl. G09B 5/06; G09B 7/00

(52) U.S. Cl. CPC G09B 5/06; G09B 7/00

(57) ABSTRACT

There is provided a computer-implemented method, system, and computer-readable medium for generating an interactive digital presentation. The system has one or more processors programmed with computer instructions to perform the method, comprising: storing a collection of digital resources, including at least some interactive digital resources, each digital resource having a plurality of associated attributes and having specified values, wherein the attributes are associated with each other in a predetermined hierarchy. A subset of the digital resources corresponding to selections of at least some of the specified values of the attributes by an authorised presenter is captured as well as the arrangement of selected digital resources in a series of successive scenes of the presentation. An interactive digital presentation comprising the series of successive scenes and selected resources is generated for transmission and interaction from one or more remote devices.

### FIELD OF THE DISCLOSURE

The present disclosure relates to a system and method for dynamically generating customised digital educational content from digital resources.

### BACKGROUND OF THE DISCLOSURE

Instructor-led classroom-based education for a cohort of students (of various ages) is typified by classroom teachers presenting a lesson on a topic to all students, at the same time and in the same physical location. This has been the traditional pedagogical model for many years. However, situations where the instructor and students are located in the same physical classroom, at the same time, have been augmented and/or substituted by a growing use of digital education, delivered remotely to student devices across computer networks, such as the Internet. In many situations, instructor-led teaching in digital form may even be delivered asynchronously, at different times and in different locations for individual students, at their convenience.

A disadvantage of remotely delivered asynchronous education (including instructor-led forms of this type of education) is that students are easily distracted and may disengage from the lesson. This disengagement can be more easily prevented or addressed when both the instructor and students are in the same physical classroom location. In such situations, good instructors may be familiar with the personalities and learning habits of individual students and/or able to monitor student body language and behaviour during lessons. In situations where the instructors and students are in the same location at the same time, good instructors often adapt their lesson to maximise student comprehension and engagement. It would be appreciated that this type of dynamic adjustment is difficult in remotely delivered learning, especially when the content presented is essentially sequential static modules, delivered as asynchronous learning.

A variety of digital resources of various formats may be utilised in an attempt to stimulate and retain interest in learning by accessing learning resources (especially asynchronous learning) over a network. It would be appreciated that it is difficult to keep such content fresh and engaging.

Unfortunately, digital content used in these settings is relatively static since it is typically time-consuming to create. It is time-consuming and difficult to adjust content to cater to the different learning aptitudes, speeds, and proficiencies of students, and to keep digital content fresh and engaging for a population of students of differing abilities. Such deficiencies detract from the usefulness of the overall digital education experience and present an impediment to adoption.

It is an object of the present disclosure to provide a method and system, which address or ameliorate at least some of the problems discussed; or at the least provide the public with additional choice.

### SUMMARY OF THE DISCLOSURE

Features and advantages of the disclosure will be set forth in the description which follows, and in part will be obvious from the description, or can be learned by practice of the herein disclosed principles. The features and advantages of the disclosure can be realized and obtained by means of the instruments and combinations particularly pointed out in the appended claims.

In accordance with the present disclosure, there is provided a system and method for generating an interactive digital presentation.

Advantageously there is provide a computer-implemented method of generating an interactive digital presentation comprising a plurality of successive scenes; the method being implemented on a computer system having one or more processors programmed with computer instructions that when executed by the one or more processors, cause the computer system to perform the method, the method comprising:
storing by the computer system, a collection of digital resources, including at least some interactive digital resources, each digital resource having a plurality of associated attributes having specified values, wherein the attributes are associated with each other in a predetermined hierarchy;
displaying by the computer system, a subset of the digital resources corresponding to selections of at least some of the specified values of the attributes by an authorised presenter;
storing by the computer system, the arrangement of the selected digital resources from the subset of digital resources in one or more scenes of the plurality of successive scenes of the presentation;
generating by the computer system an interactive digital presentation comprising the series of successive scenes and selected resources embedded therein for transmission to one or more remote devices operable by an authorised user and for receiving input from one or more interactive resources in the selected resources thereon.

Optionally the attributes may be selected from the group comprising curricula, curriculum levels, topics, language components, subtopics, levels, and types.

Optionally the digital interactive resources may be selected from the group comprising simulated cards and prompts and responses. Preferably the simulated cards displaying predefined content on the front/back thereof may be changeable upon detection of actuation on the one or more remote device or of the completion of answers to the interactive questions on the one or more remote devices. The cards may include words or phrases in at least both a first language and a second language; said words or phrases also being associated with the selected attributes of the predetermined hierarchy. Alternatively, the cards may include only words or phrases in one language.

Optionally the method may comprise further including receiving student responses to interactive resources and associating the evaluated response with a corresponding record for that student on the system for generation of a report therefrom.

The arrangement of the digital resources in the plurality of successive slides may be by the authorised presenter or generated automatically according to specified attributes.

The digital resources may include words in a first language and corresponding words in a second language, automatically generated from an external data store containing the association between said words of the first and second languages.

Each successive slide may comprise a frame rendered by a browser with each of the digital resources overlaid thereupon.

In a further aspect, there is provided a system configured for generating an interactive digital presentation comprising a plurality of successive scenes; the system comprising:
non-transitory electronic storage configured to store a collection of digital resources, including at least some interactive digital resources, each digital resource having a plurality of associated attributes having specified values, wherein the attributes are associated with each other in a predetermined hierarchy;
one or more physical processors configured by machine-readable instructions to receive and store the selections and arrangement of a subset of the digital resources in an interactive presentation by receiving the selection of at least some of the specified values of the attributes by an authorised presenter
one or more remote devices configured to display the interactive presentation comprising the series of successive screens and selected resources embedded therein for transmission to one or more remote devices operable by an authorised user and for receiving input from one or more interactive resources in the selected resources thereon.

Preferably the attributes may be selected from the group comprising curricula, curriculum levels, topics, language components, subtopics, levels, and types.

The digital interactive resources may be selected from the group comprising simulated cards and prompts and responses. Said simulated cards may be configured to display predefined content on the front/back thereof, which are changeable upon detection of actuation on the one or more remote device or of the completion of answers to the interactive questions on the one or more remote devices. The cards may include content in at least both a first language and a second language; said words or phrases also being associated with the selected attributes of the predetermined hierarchy.

Preferably, the one or more physical processors are configured to receive student responses to interactive resources and associate an evaluation of the response with a corresponding record for that student on the system for generation of a report therefrom.

The arrangement of the digital resources in the plurality of successive slides may be by the authorised presenter or generated automatically according to specified attributes.

Optionally, the digital resources include words in a first language and corresponding words in a second language automatically generated from an external data store containing the association between said words of the first and second languages.

Preferably, each successive slide comprises a frame rendered by a browser with each of the digital resources overlaid thereupon.

### BRIEF DESCRIPTION OF THE DRAWINGS

In order to describe the manner, in which the above-recited and other advantages and features of the disclosure can be obtained, a more particular description of the principles briefly described above will be rendered by reference to specific embodiments thereof, which are illustrated in the appended Figures. Understanding that these Figures depict only exemplary embodiments of the disclosure and are not therefore to be considered to be limiting of its scope, the principles herein are described and explained with additional specificity and detail through the use of the accompanying Figures.

Preferred embodiments of the present disclosure will be explained in further detail below by way of examples and with reference to the accompanying Figures, in which:—

FIG. 1A depicts an exemplary schematic representation of an aspect of the system providing an authoring environment and hosting for resources, records, and digital presentations.

FIG. 1B depicts an exemplary schematic representation of an embodiment of the system in which an embodiment of the present disclosure is hosted.

FIG. 2A depicts one scene of an exemplary presentation, in this case, about teaching and learning, which is presented to the user.

FIG. 2B depicts a further scene of the exemplary presentation of FIG. 2A, which is presented to the user.

FIG. 2C depicts yet a further scene of the exemplary presentation of FIG. 2A, which is presented to the user.

FIG. 2D depicts still another scene of the exemplary presentation of FIG. 2A, which is presented to the user.

FIG. 2E depicts a further scene of the exemplary presentation of FIG. 2A, which is presented to the user.

FIG. 3 depicts an exemplary authoring view for an authorised presenter for preparing a presentation.

FIGS. 4A-4D depict exemplary administrator views presented to an authorised presenter generating additional digital resources.

FIG. 5A shows an exemplary entity relationship diagram for an exemplary arrangement of tags.

FIG. 5B shows an exemplary hierarchical arrangement of attributes/tags.

### DETAILED DESCRIPTION OF THE PREFERRED EMBODIMENTS

Various embodiments of the disclosure are discussed in detail below. While specific implementations are discussed, it should be understood that this is done for illustration purposes only. A person skilled in the relevant art will recognize that other components and configurations may be used without departing from the spirit and scope of the disclosure.

The disclosed technology addresses the need in the art for a method and system of managing generation and delivery of digital resources in a controlled yet customisable manner.

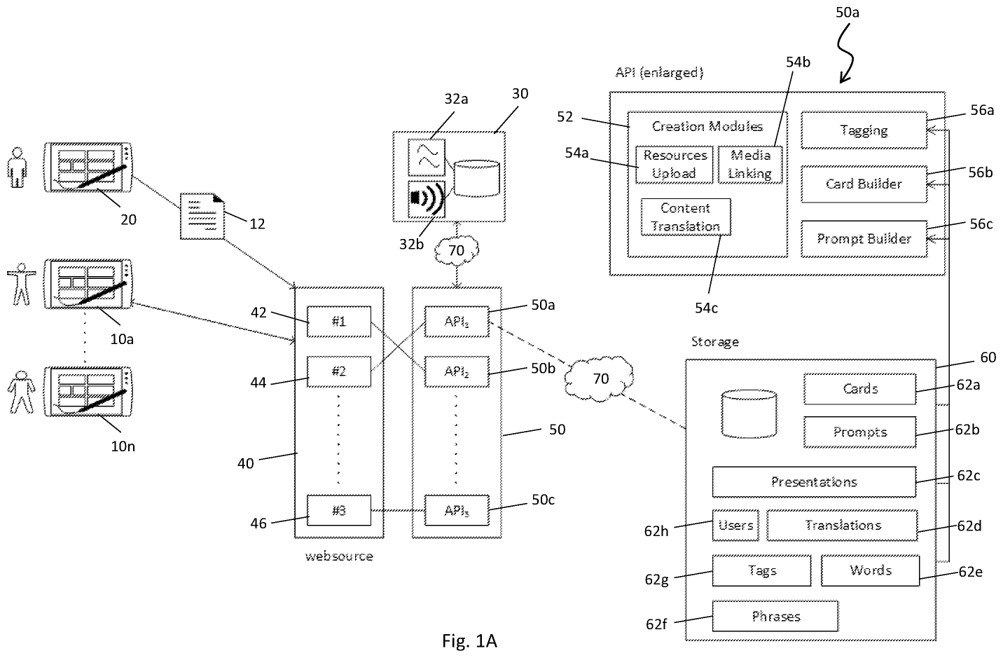

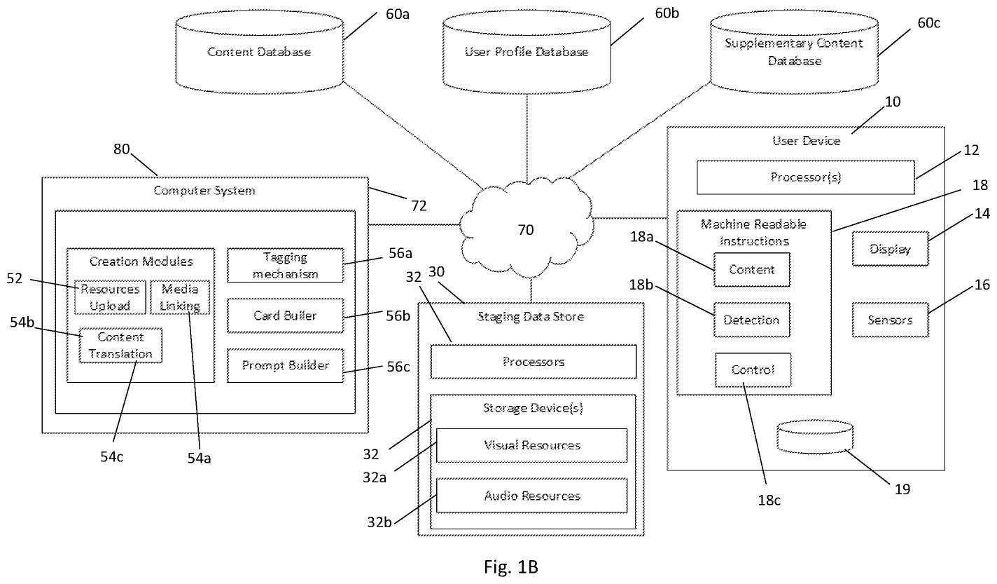

Referring to FIG. 1A and FIG. 1B, there are, depicted, two alternate representations of an exemplary architecture of the system of the present disclosure.

As depicted, authorised user devices 10 request over a network such as the internet or similar via a web server 40 a specific presentation 12 upon actuation of a selection from appropriate presentations displayed to the user of the device. Advantageously, the web server 40 may be an instance of a Nginx web server/load balancing web proxy server or similar. The user request for a presentation is passed back via an Application Programming Interface (API) to a staging data store 30, which stores the position, sequence and arrangement of interactive digital visual resources 32a, and digital audio resources, 32b in the plurality of scenes, which comprise the specific presentation. These digital interactive resources may comprise simulated cards and prompts and responses.

Once delivered to the authorised licensed user 10, they are able to interact with the various digital assets of the presentation as discussed herein. Such interactions may advantageously be captured and associated with user records for evaluation of performance of that user in interacting with the presentation.

The specific presentations 12 may be prepared by another authorised user 20 e.g. for a cohort of users having similar age, learning program, or levels, or to user 10a or cohort of users as is described further herein.

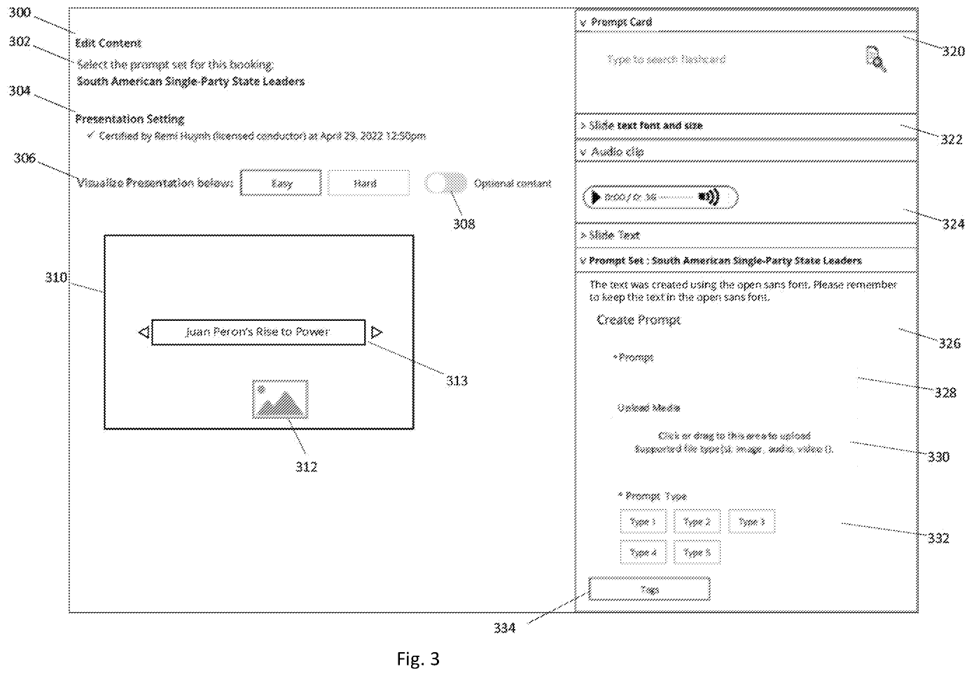

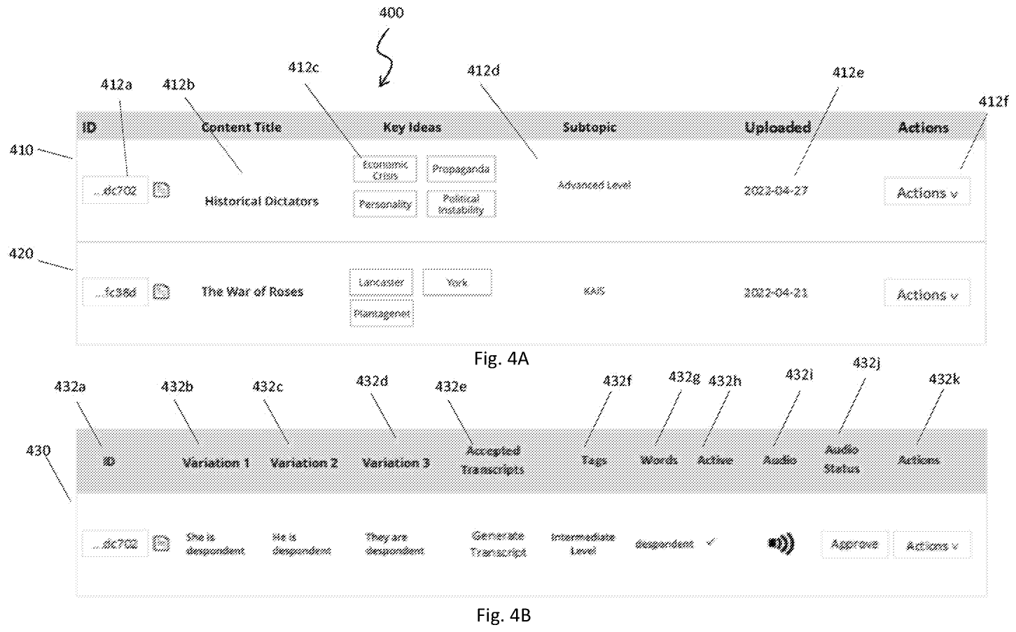

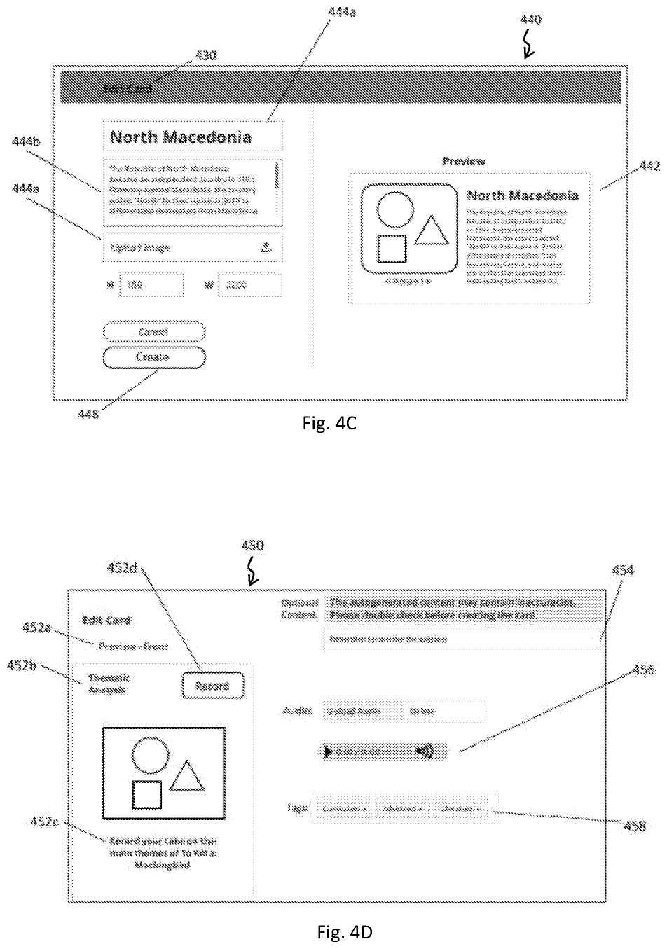

Alternatively, without departing from the scope of the present disclosure the presentation 12, could potentially be generated with a specific individual user 10 or cohort of similar users in mind. The visual resources 32a (text, image, image streams, cards etc, prompts and responses) and audio resources 32b in the specified presentation on the staging data store may be created by access of the authorised user 20 to the web server 40 to the authoring platform described herein with reference to FIGS. 3 and 4A-D. Advantageously this access is mediated by the Application Programming Interface 50a, 50b etc.

As is depicted in FIG. 1, the application programming interface instances 50a, 50b etc. can be thought of as conceptually comprising a plurality of submodule interfaces 54 a,b,c and 56 a,b,c for performing various operations.

These modules may include in an exemplary embodiment content creation module 52, in which resource upload 54a, media linking 54b and content translation sub-modules 54c may be configured. Advantageously the resource upload module 54a manages the upload of the completed specified presentations 12, while media linking module 54b ensures that the resources are associated appropriately together in the presentation. The content translation module 54c manages the translation of text between specified language pairs.

In order to facilitate reuse of content in various presentations as described herein, the tagging frameworks enables authorised presenters to associate particular attributes with content created. These attributes may include curricula, curriculum levels, topics, language components, subtopics, levels, and types. or other attributes as appropriate to facilitate reuse of the content in various user presentations.

Also depicted, is a card builder module 56b. In the system and method of the present disclosure, a card typically comprises predefined content on the front/back thereof, which is changeable upon detection of actuation on the one or more remote devices or of the completion of answers to the interactive questions on the one or more remote devices. This enhances user engagement and interaction in the learning process and may be controlled by an authorised presenter, as is described further with reference to subsequent figures.

As depicted in FIG. 1A and FIG. 1B an exemplary API 50a is in communication across a wired or wireless network 70 with various digital resources/user information, which are stored on a network accessible data store 60. Advantageously, these resources/user information may include digital cards 62a, prompts and responses 62b, already completed presentations 62c, translations of phrases 62d, words 62e (words which are part of a vocabulary, which are repeated in a particular subject, group, or level, according to learning objective), phrases 62f, tags 62g, in addition to user information 62h (e.g. logins, performance, and various other records).

An exemplary hardware implementation of the arrangement depicted in FIG. 1A is shown in FIG. 1B.

As depicted, user device 10 includes a processor 12, display 14, and sensors 16 for receiving user input. Machine-readable instructions 18 comprise information on the presentation content 18a, detection of interaction 18b, progression 18c, and a data store for temporary storage 19.

The staging data store 30 may be configured to include processors 34, and storage device 32, in which the visual resources 32a and audio resources 32b are disposed.

Advantageously, the API may be hosted on a server 80 with processors 82 having various creation modules 52, such as the resource upload module 54a, media linking module 54b, content translation module 54c, content management module 56a, card builder 56b, and prompt builder 56c.

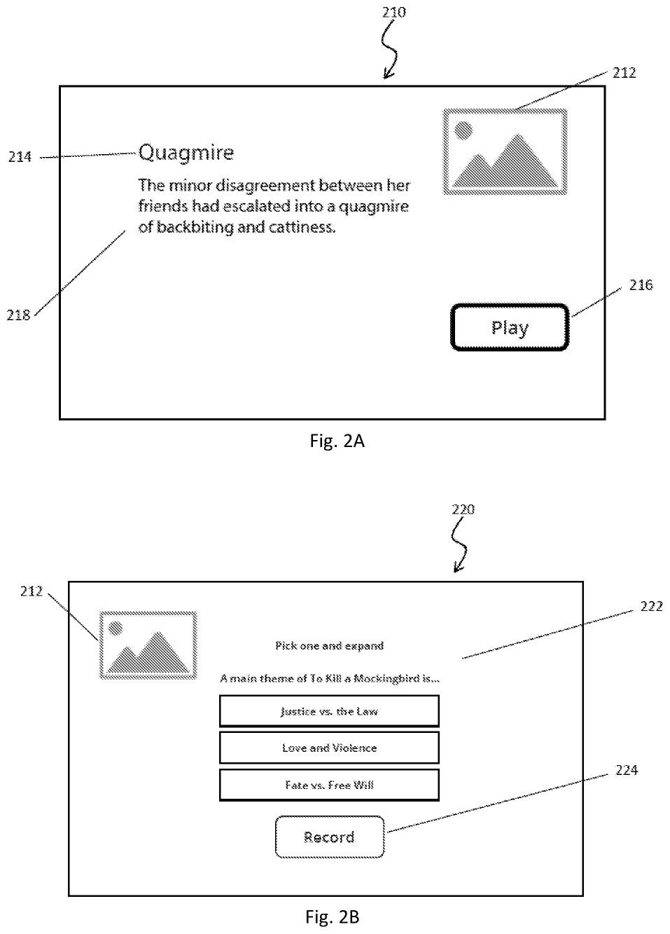

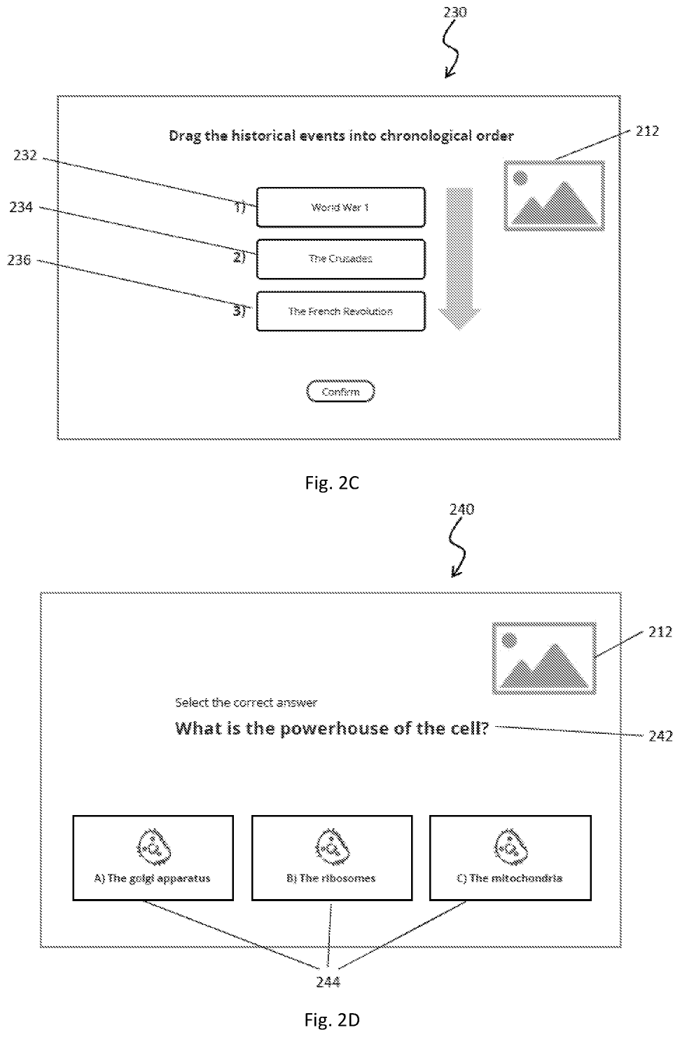

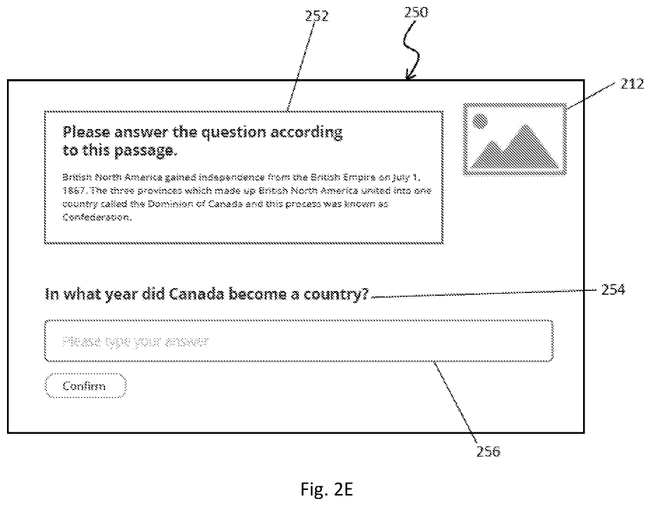

Referring to FIGS. 2A-2E, there is depicted various scenes in a presentation, which advantageously shares a common topic/subtopic; which may be associated with a particular subject in an overall curriculum.

As depicted in FIG. 2A, the scene 210 may include a background image 212, and a word 214 may appear.

An audio recording of that word may be accessed through the button 216 and an exemplary phrase to provide context for the word 214 may also be included 218 to enhance user engagement and learning.

In the next scene or slide 220, depicted in FIG. 2B in the presentation, an exemplary prompt 222 and an option for the user to input or record a response 224 are depicted on the same or similar image background 212.

In the next scene or slide 230 depicted in FIG. 2C in the presentation, elements are presented in an order, which may be changed by the user 232, 234, and 236, together with an appropriate body and image 212.

In the next scene or slide 240 depicted in FIG. 2D in the presentation, a question 242 and possible answers 244 are presented for the user to select from.

Finally, in FIG. 2E, a scene or slide 250 is depicted in which a passage of text 252 is displayed, together with a related prompt 254 and space provided for the user to respond 256.

User performance in the interaction may be assessed against appropriate responses associated with the interactive resources in the scene, and performance of a specific user in a particular presentation may be recorded and evaluated at a later point in time.

In this way, the presentation of successive slides or scenes can provide a variety of different formats to engage the user's attention, using interactive digital elements, such as audio, video, and prompt text, supported by images associated with a common topic. As discussed below, once these elements have been created for a presentation, they may be re-used in similar presentations, according to their specified attributes. It would be appreciated that the successive slides or scenes may be share a common theme or topic as is discussed in more detail below; although this may not necessarily be the case as can be seen from the exemplary topics depicted in FIG. 2a to FIG. 2e.

Referring now to FIG. 3, there is depicted an exemplary authorised presenter view 300, which is displayed on an authorised presenter device 20 upon transmission across the network 70 and is available for authorised presenters to assemble, configure, and modify presentations comprising successive scenes, in which there are included, various interactive digital resources, as depicted in FIGS. 2A-FIG. 2E.

As depicted, an authorised presenter is able to select a set of prompts 302, although other content types can also be selected if available. In order to ensure that the content has been verified as correct, an optional validation entry can be displayed at 304 as depicted. Optionally, in the exemplary embodiment depicted, the type of content displayed may be selected from different variations, as noted 306. Furthermore, the additional optional content may be toggled on/off by an authorised presenter, using the button 308. It would be appreciated that the context of the scene displayed is in a presentation for learning and a variety of different or alternative topics could be displayed without departing from the scope of the present disclosure.

Advantageously, the content may be configured such that the text properties are updated based upon the demographic of the user. For example, depending on whether the user is in a region where one variation of the content is common, as opposed to a second variation of the same content. The text may be replaced with an appropriate stored value at time of rendering. The underlying storage of the cards, prompts, slides and static content may be stored in a first variation; although the actual content presented to the user may be in an appropriate variation for the user; which may be a second variation) based upon substitution by the automated translation presentation engine. For example, this may be understood in a non-limiting example whereby Simplified Chinese text may be replaced by Traditional Chinese text (or vice versa).

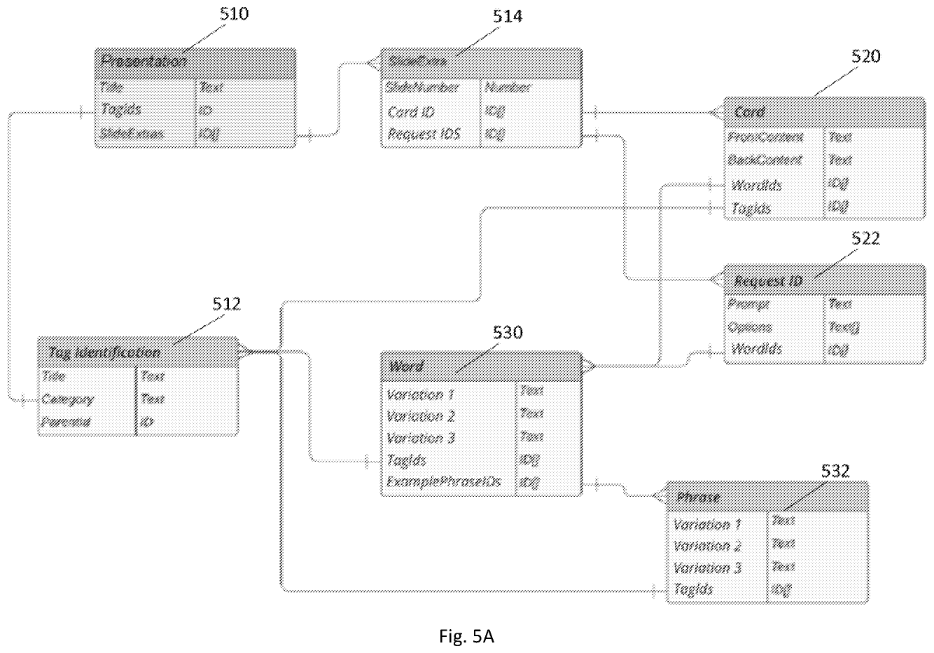

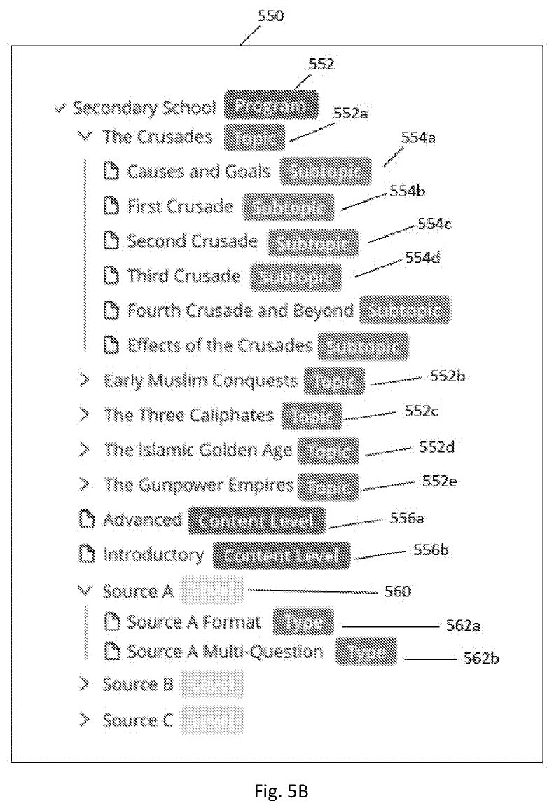

A preview of a scene in the presentation is depicted in the frame 310. Background image 312 may be overlaid by a phrase 313 (in this case, “Juan Peron's Rise to Power”). Various additional resources, such as a card, could also be searched and inserted and/or created and inserted using the card module interface 320 in the scene. Variations can be chosen using the interface 322, while audio clips of relevant content could be stored using the audio clip module 324. A prompt authoring module 326 provides the ability for a user to type a prompt in the text box 328 and associate supporting media by navigating to an appropriate file path 330. The prompt type may be specified using the attributes depicted FIG. 5B. Optionally, hints in the form of text or media may also be provided (not shown). Tags 334 provide additional information and facilitate a way in which the digital resources may be created, located, and reused, preferably in an attribute hierarchy as described further herein.

Referring now to FIGS. 4A-4E, there is depicted a further configuration level view for an authorised presenter with an appropriate level of access. Through such access, an appropriately authorised presenter can access the underlying assets and presentations of the various elements that comprise the various digital resources, which are used in the successive scenes of the presentations.

As depicted in the exemplary view 400 of FIG. 4A, various content sets 410, 420 are represented by uniquely identified rows with a unique identifier 12a and have various attributes, including content title 412b and key ideas 412c. These items are associated with various subtopics for an advanced level and have already been used in a number of other content sets, as depicted in 412d. The upload date and time information can be logged in field 412e. Actions, such as editing text, changing the audio, adding tags and associate words, and generating cards, can be taken 412f.

Resources, such as words or phrases, may be created as digital resources using an exemplary interface 430, such as that depicted in FIG. 4B. As shown, unique identifier 432a is for the text “She is despondent” 432b, together with the second variation 432c and third variation (432d). A transcript of this phrase can be generated 432e. Tags 432f specify the level to which this text might be applicable. Important words in the phrase can be identified in 432g, status information 432h, together with supporting recorded audio 432i and associated audio status 432j. Similarly, actions, such as editing text, changing the audio, adding tags and associate words, and generating cards, can be taken 432k.

As depicted in FIG. 4C, the arrangement of various resources in each scene may also be configurable by an authorised licensed user. As depicted, the user interface 440 includes a preview portion 442 of the scene of a presentation and includes a function to add an image 444a, a text box for receiving input 444b and enables the user to save the scene and proceed, using controls 448.

Referring to FIG. 4D, there is presented an exemplary user interface 450 in which the content of a simulated digital card may be edited and then saved as a digital resource in the data store. As depicted, the screen 450 may include predefined content on the front/back thereof, which is changeable upon detection of actuation on the one or more remote devices, or of the completion of responses to the interactive prompts on the one or more remote devices.

As shown, the preview may be toggled between a preview of front content and back content by actuation of button 452a. The prompt on the card may be provided as depicted by text at 452b, with the specific query text being included at 452c. A button 452d is provided so that the user may actuate the record button on their remote device to record their answer; and then the user is able to listen to a pre-recorded audio of the same question, based upon the pre-recorded audio which has been uploaded at 456. Additional optional content can be generated and associated with the resource as depicted at item 454. Advantageously, at the same time as developing the card digital resource shown, tags may also be specified using the input box at 458 enabling this same resource to be located and re-used in other contexts/presentations.

Referring to FIG. 5A, there is depicted an exemplary entity relationship diagram of various digital resources, which may be used in an embodiment of the present disclosure.

As depicted, the presentation 510 includes a title and one or more forms of tag identification information 512, as well as scene extras 514 (which advantageously defines which interactive resources are associated with that scene). Optionally, as depicted, these interactive resources may include digital cards 520 and requests 522 as shown. In the case of cards 520, these may have information, including front content, back content, word identifications, and tag identifications. In some embodiment, such cards 520 may not necessarily be associated with word or phrase concepts.

In the case of request-related digital resources, the information captured may include prompts, options, and associations with words. As depicted, each tag 512 includes title, category, and Parent ID (which is often a reference to another tag).

In an educational exercise, various words 530 may each include appropriate attributes, in this case, variation 1, 2, and 3, as well as relevant tag information. Each word 530 may in turn, include references to phrases 532 as depicted, which in turn are associated with various tags. The circularity of tags described facilitates retrieval and development of presentations.

An exemplary organisation of the tag organisation in a hierarchical schema is depicted in FIG. 5B. In this exemplary schema 550 shown; the top level program 552 comprises certain topics 552a, 552b, 552c, 552d, 552e, which comprise various subtopics 554a, 554b etc. The top level program may also comprise subtopics 554a, 554b, etc, and content with various levels 560, with supporting material 562a, 562b. It would be appreciated that the various associations between levels of the hierarchy could be developed as required by a particular program and with a view to enhancing rapid location and usage of relevant digital resources in the future.

It would be appreciated that the above arrangements of tags (attributes) are exemplary only; and various other arrangements would also be possible without departing from the scope of the present disclosure.

As described herein, the present disclosure provides an interactive digital experience with a number of successive scenes comprising interactive digital elements, such as cards or prompt and response pairings. Once created, through the use of easily specified attributes, such as topic, curriculum, level etc, digital resources may be reused and repurposed to easily customise presentations depending on the aptitude and performance of the student. Over time, it would be appreciated that the resources increase; and may be easily refreshed to enable the content to stay fresh and engaging for the users of the experience. At the same time, the authoring environment provides a simple yet powerful graphical user interface facilitating rapid development of digital resources by appropriately authorised presenters. Furthermore, the interactive digital elements exist within a highly organized instructive system, creating a dynamic learning experience through which insights can be derived from user input.

The above embodiments are described by way of example only. Many variations are possible without departing from the scope of the disclosure as defined in the appended claims.

For clarity of explanation, in some instances, the present technology may be presented as including individual functional blocks, including functional blocks comprising devices, device components, steps or routines in a method embodied in software, or combinations of hardware and software.

Methods according to the above-described examples can be implemented using computer-executable instructions that are stored or otherwise available from computer-readable media. Such instructions can comprise, for example, instructions and data, which cause or otherwise configure a general purpose computer, special purpose computer, or special purpose processing device, to perform a certain function or group of functions. Portions of computer resources used can be accessible over a network. The computer-executable instructions may be, for example, binaries, intermediate format instructions, such as assembly language, firmware, or source code. Examples of computer-readable media that may be used to store instructions, information used, and/or information created during methods according to described examples include magnetic or optical disks, flash memory, Universal Serial Bus (USB) devices provided with non-volatile memory, networked storage devices, and so on.

Devices implementing methods according to these disclosures can comprise hardware, firmware, and/or software, and can take any of a variety of form factors. Typical examples of such form factors include laptops, smart phones, small form factor personal computers, personal digital assistants, and so on. Functionality described herein also can be embodied in peripherals or add-in cards. Such functionality can also be implemented on a circuit board among different chips or different processes executing in a single device, by way of further example.

The instructions, media for conveying such instructions, computing resources for executing them, and other structures for supporting such computing resources are means for providing the functions described in these disclosures.

Although a variety of examples and other information was used to explain aspects within the scope of the appended claims, no limitation of the claims should be implied based on particular features or arrangements in such examples, as one of ordinary skill would be able to use these examples to derive a wide variety of implementations. Further and although some subject matter may have been described in language specific to examples of structural features and/or method steps, it is to be understood that the subject matter defined in the appended claims is not necessarily limited to these described features or acts. For example, such functionality can be distributed differently or performed in components other than those identified herein. Rather, the described features and steps are disclosed as examples of components of systems and methods within the scope of the appended claims.

1. A computer-implemented method of generating an interactive digital presentation comprising a plurality of successive scenes; the method being implemented on a computer system having one or more processors programmed with computer instructions that when executed by the one or more processors, cause the computer system to perform the method, the method comprising:
storing by the computer system, a collection of digital resources, including at least some interactive digital resources, each digital resource having a plurality of associated attributes having specified values, wherein the attributes are associated with each other in a predetermined hierarchy;
displaying by the computer system, a subset of the digital resources corresponding to selections of at least some of the specified values of the attributes by an authorised presenter;
storing by the computer system, the arrangement of the selected digital resources from the subset of digital resources in one or more scenes of the plurality of successive scenes of the presentation;
generating by the computer system an interactive digital presentation comprising the series of successive scenes and selected resources embedded therein for transmission to one or more remote devices operable by an authorised user and for receiving input from one or more interactive resources in the selected resources thereon.

2. The computer-implemented method of generating an interactive digital presentation comprising a plurality of successive scenes, according to claim 1, wherein the attributes are selected from the group comprising curricula, curriculum levels, topics, language components, subtopics, levels, and types.

3. The computer-implemented method of generating an interactive digital presentation comprising a plurality of successive scenes/slides, according to claim 1, wherein the digital interactive resources are selected from the group comprising simulated cards and prompts and responses.

4. The computer-implemented method of generating an interactive digital presentation comprising a plurality of successive scenes, according to claim 3, wherein said simulated cards displaying predefined content on the front/back thereof are changeable upon detection of actuation on the one or more remote device or of the completion of answers to the interactive questions on the one or more remote devices.

5. The computer-implemented method of generating an interactive digital presentation comprising a plurality of successive scenes, according to claim 3, wherein the cards include words or phrases in at least both a first language and a second language; said words or phrases also being associated with the selected attributes of the predetermined hierarchy.

6. The computer-implemented method of generating an interactive digital presentation comprising a plurality of successive scenes, according to claim 1, further including receiving student responses to interactive resources and associating the evaluated response with a corresponding record for that student on the system for generation of a report therefrom.

7. The computer-implemented method of generating an interactive digital presentation comprising a plurality of successive scenes, according to claim 1, wherein the arrangement of the digital resources in the plurality of successive slides is by the authorised presenter or generated automatically according to specified attributes.

8. The computer-implemented method of generating an interactive digital presentation comprising a plurality of successive scenes, according to claim 1, wherein the digital resources included words in a first language and corresponding words in a second language, automatically generated from an external data store containing the association between said words of the first and second languages.

9. The computer-implemented method of generating an interactive digital presentation comprising a plurality of successive scenes, according to claim 1, wherein each successive slide comprises a frame rendered by a browser with each of the digital resources overlaid thereupon.

10. A system configured for generating an interactive digital presentation comprising a plurality of successive scenes; the system comprising:
non-transitory electronic storage configured to store a collection of digital resources, including at least some interactive digital resources, each digital resource having a plurality of associated attributes having specified values, wherein the attributes are associated with each other in a predetermined hierarchy;
one or more physical processors configured by machine-readable instructions to receive and store the selections and arrangement of a subset of the digital resources in an interactive presentation by receiving the selection of at least some of the specified values of the attributes by an authorised presenter;
one or more remote devices configured to display the interactive presentation comprising the series of successive screens and selected resources embedded therein for transmission to one or more remote devices operable by an authorised user and for receiving input from one or more interactive resources in the selected resources thereon.

11. The system according to claim 10, wherein the attributes are selected from the group comprising curricula, curriculum levels, topics, language components, subtopics, levels, and types.

12. The system according to claim 10, wherein the digital interactive resources are selected from the group comprising simulated cards and prompts and responses.

13. The system according to claim 12, wherein said simulated cards display predefined content on the front/back thereof, which is are changeable upon detection of actuation on the one or more remote device or of the completion of answers to the interactive questions on the one or more remote devices.

14. The system according to claim 12, wherein the cards include content in at least both a first language and a second language; said words or phrases also being associated with the selected attributes of the predetermined hierarchy.

15. The system according to claim 10, wherein the one or more physical processors are configured to receive student responses to interactive resources and associate an evaluation of the response with a corresponding record for that student on the system for generation of a report therefrom.

16. The system according to claim 10, wherein the arrangement of the digital resources in the plurality of successive slides is by the authorised presenter or generated automatically according to specified attributes.

17. The system according to claim 10, wherein the digital resources included words in a first language and corresponding words in a second language automatically generated from an external data store containing the association between said words of the first and second languages.

18. The system according to claim 10, wherein each successive slide comprises a frame rendered by a browser with each of the digital resources overlaid thereupon.
